(19) United States
(12) Patent Application Publication
(10) Pub. No.: US 2013/0162036 A1
(43) Pub. Date: Jun. 27, 2013

(54) Complementary Detection of Power Supplies Stability and Notifying Multiple Domains Regardless of Other Power Domains Readiness

(71) Applicants: Jason J. Mangattur, Thornhill (CA); Richard W. Fung, Thornhill (CA); Marcus Ng, East York (CA)

(72) Inventors: Jason J. Mangattur, Thornhill (CA); Richard W. Fung, Thornhill (CA); Marcus Ng, East York (CA)

(21) Appl. No.: 13/336,481

(22) Filed: Dec. 23, 2011

(51) Int. Cl. H02J 4/00

(52) U.S. Cl. 307/18

(57) ABSTRACT

A method and apparatus for powering up an integrated circuit having a plurality of power domains each coupled to receive power from one of a plurality of power sources, where each power domain includes an internal power detector which senses the power of a plurality of power domains (VDD1, VDD2, VDD3, . . . , VDDn) and compares them to a reference voltage to generate a combined power good (PG) signal. The PG signal is combined with an external system power ok signal at a plurality of AND gate circuits which are respectively powered by the plurality of power domains, thereby generating a plurality of power status signals (POWER_OK) on the destination power domains.

### BACKGROUND OF THE INVENTION

1. Field of the Invention

The present invention relates in general to the field of electronic circuits. In one aspect, the present invention relates to a method and apparatus powering electronic circuits.

2. Description of the Related Art

In many integrated electronic circuits, multiple different voltage power supply levels are provided for different circuit portions, such as core logic, analog circuits and input output interfaces, and any other suitable circuits. With multi-voltage or “split-rail” circuits, each circuit portion may have different power levels, high drive voltage levels, and maximum allowable voltage levels, depending on the type of transistor technology and design used at each circuit portion. The use of different types of transistors and power supply levels can create design challenges since transistors can be damaged by excessive gate-source voltages (Vgs) that are created when power supply voltages are improperly supplied to the transistors. Accordingly, a reliability challenge for designing integrated circuits is to power up the split-rail circuit portions with a power-up circuit or sequence that keeps the gate-source voltage Vgs below a maximum allowable gate-source voltage Vgs-max. This challenge is complicated in cases where circuit operations in one power domain depend on inputs from another power domain which may not be available.

### SUMMARY OF EMBODIMENTS OF THE INVENTION

Broadly speaking, the present invention provides a method and apparatus for powering electronic circuits by providing complementary detection of the stability of multiple power supplies with power good notifications to multiple domains that do not depend on the readiness of unrelated power domains. To correctly signal power domain readiness in a multi-power domain integrated circuit, each power domain combines both internal and external power supply detection. First, each power domain receives only the external power good information (PowerOK) for its domain so that there are no inter-power-domain dependencies. Second, each power domain includes an internal power or voltage detector to detect that the power the external power is sent on is valid. The internal power detector circuit may be configured to sequentially compare the power of various power domains to a reference voltage and generate logic output values based on the comparison which can be stored and/or logically combined at a multi-input AND gate to generate a PowerGood (PG) signal. By combining the external power good information (PowerOK) with the internal PowerGood (PG) signal with an AND gate on the destination power domain, each power domain is provided with its own robust power up signal (POWER_OK) on its own power domain, thereby allowing robust power up since all voltage domains are reliably-notified that all the relevant powers are up. In addition, the disclosed power detection arrangement provides fast detection when powers are being removed (e.g., from improper shutdown of system).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a circuit block diagram depiction of a plurality of voltage regulators connected on a motherboard to provide an external power rail signal to an accelerated processing unit which uses series cascoded devices as a power detection circuit to address glitches in the power rail signal.

FIG. 2 shows a circuit block diagram depiction of a power rail detection circuit which uses an internal power detection circuit to generate a power good signal when all power rails are safe and logically combines the power good signal with the external power rail signal to provide a power status indication to each power domain.

FIG. 3 shows a circuit block diagram of an internal power detection circuit in accordance with selected embodiments of the present invention.

FIG. 4 depicts a process flow sequence for implementing selected embodiments of the present invention.

### DETAILED DESCRIPTION

A reliable and robust power up detection circuit and associated method of operation are described for notifying multiple power domains of the power supply status by including both internal and external power supply detection schemes together to logically combine the internal and external power good signals with an AND gate on the destination power domain. By logically combining internal and external power good supply signals in this way, glitches from the external power good supply signal are prevented from disturbing the circuit status.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified block diagram depictions rather than in detail in order to avoid limiting or obscuring the present invention.

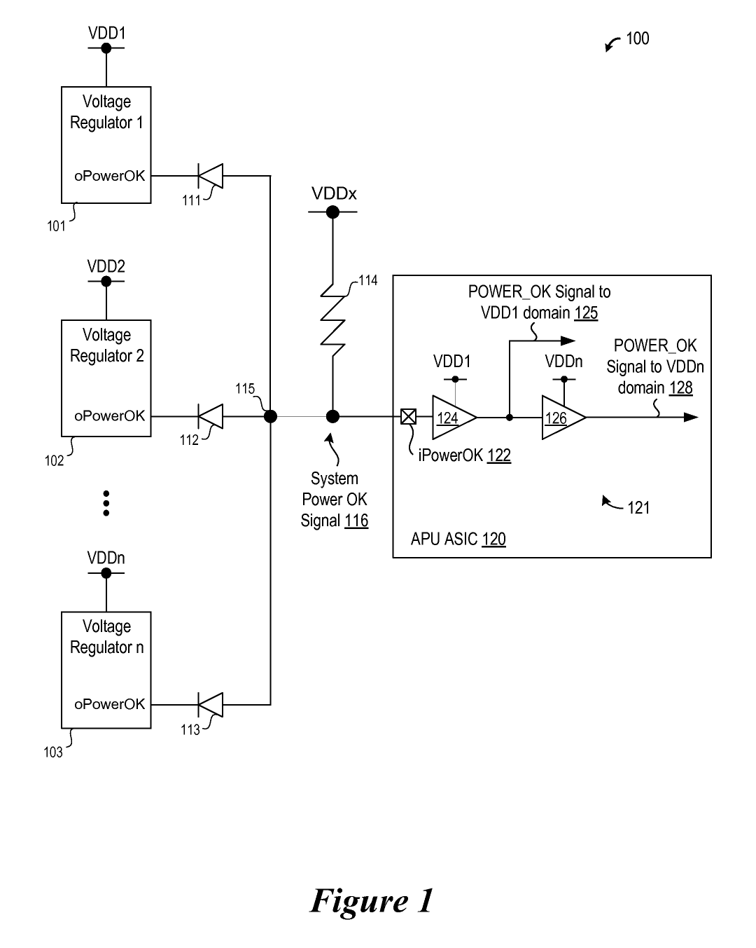

To provide a contextual understanding for selected embodiments of the present invention, reference is now made to FIG. 1 which is a circuit block diagram of a motherboard system 100 having an accelerated processing unit (APU) application specific integrated circuit (ASIC) 120 which requires multiple different voltage power supply levels for different circuit areas of the ASIC 120, such as core logic, analog circuits and input output interfaces, and any other suitable circuits. For example, on the APU ASIC 120, core logic may operate at 0.9 volts while analog circuits or I/O interfaces on the same APU ASIC 120 may operate at 1.8, 3.3 or 5 volt levels. In this arrangement, the APU ASIC 120 may be partitioned into multiple power domains that can have their operating voltage individually controlled so that the APU ASIC 120 may be configured to operate in one or more power states, where each power state corresponds to a snapshot of the operating voltages for all power domains. A power domain may be defined as a circuit or groups of circuits which have the same power requirements and thus share a common power source. More particularly, a power domain may be defined as a circuit or group of circuits that operate at the same voltage. With integrated circuits having multiple power domains, there are many power states where some of the power domains may or may not be present. Also, during initial power up, power domains may come up in any order.

To provide the different supply voltages, a plurality of voltage regulators 1, 2, 3 may be connected on a motherboard to the APU ASIC 120, but must be done so in a way that the APU ASIC 120 can accommodate the different voltage levels without overstressing the transistors in the different circuit areas. A well known technique for preventing overstressing is to provide the APU ASIC 120 with an external signal from the motherboard which contains information regarding the readiness of the power rails. In FIG. 1, the external signal is generated by connecting each voltage regulator 101, 102, 103 for each power domain VDD1, VDD2, VDDn across a corresponding diode 111, 112, 113 to a shared signal node 115. Connected across load resistor 114 to supply voltage VDDx, the shared signal node provides an external signal 116 (System PowerOK Signal) to the APU ASIC 120 which contains information regarding the readiness of the power rails VDD1, VDD2, VDDn. With this arrangement, a voltage regulator (e.g., Voltage Regulator 1) that is not ready (i.e., it is not powered up yet) will drive its output power status pin (oPowerOK) low, thereby rendering its corresponding diode 111 conductive to pull the System PowerOK signal 116 low. Conversely, When Voltage Regulator 1 is powered up and ready, the output power status pin (oPowerOK) is driven HIGH to turn OFF its corresponding diode 111. When all voltage regulators are ready, the System PowerOK signal 116 is pulled HIGH by the VDDx rail. While the arrangement effectively combines power status information from all relevant power domains together, the System PowerOK signal 116 is susceptible to glitches generated by voltage regulators.

To prevent susceptibility to glitches in the external power rail signal 116 and prevent overstressing from overvoltage conditions, the APU ASIC 120 may include an internal analog power-detection circuit 121 which uses cascade buffer devices 124, 126 to address glitches in the power rail signal 116. As illustrated, the cascade buffer devices 124, 126 are connected series between the input pin 122 for the System PowerOK signal 116 and the power status signals 125, 128 to the various output domains VDD1, VDDn. In these scenarios, there is usually a minimum of two different power supply voltage levels VDD1, VDDn that are coupled, respectively, to the cascade buffer devices 124, 126. Thus, the first cascade buffer device 124 is powered by the first power supply VDD1 to receive the System PowerOK signal 116 and generate therefrom a first power status signal 125 (POWER_OK Signal) that is sent to the first VDD1 power domain. The second cascade buffer device 126 is powered by a second power supply VDDn to receive the first power status signal 125 and generate therefrom a second power status signal 128 (POWER_OK Signal) that is sent to the second VDDn power domain. During normal operating conditions of the APU ASIC 120 when both VDD1 and VDDn have been fully powered up, the power supplies VDD1, VDDn turn on in sequence to generate power status signals 125, 128 which indicate the power status to their respective power domains. However, if the second power supply VDDn is powered up before the first power supply, the buffer device 126 on the VDDn domain will be driven with an unknown value (logic-X) which may lead to a false high for the output POWER_OK signal 128 to the VDDn domain.

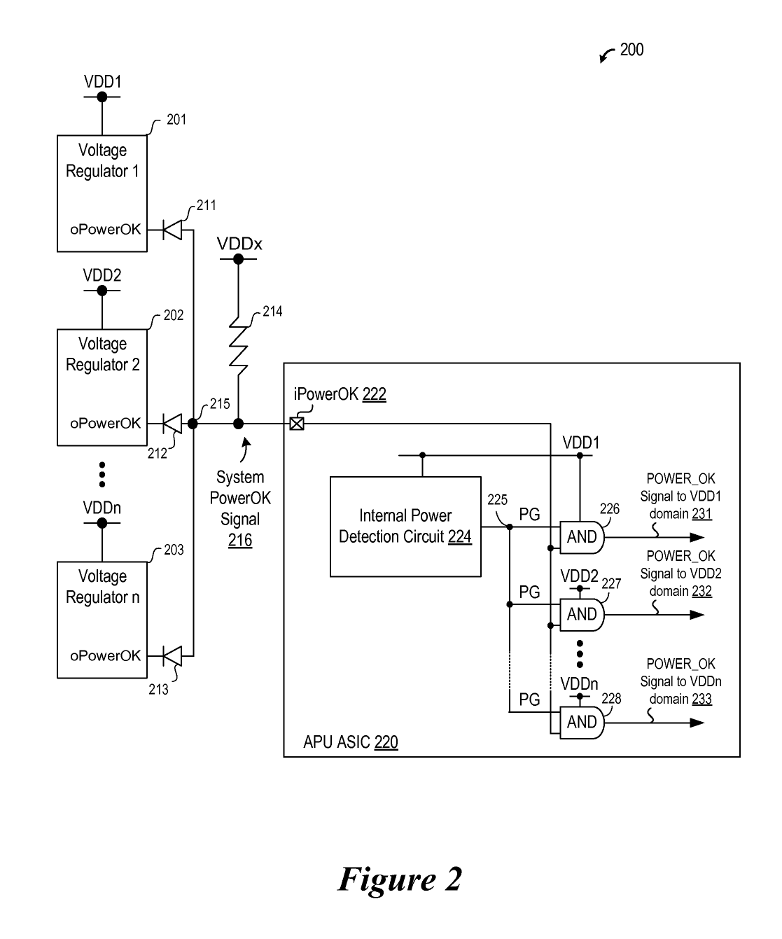

In order to avoid the power sequencing requirement and protect against voltage regulator glitches, a method and apparatus are provided for powering electronic circuits by providing each power domain with an external signal (indicating the readiness and stability of multiple power supplies) and an internally generated power good signal (which detects when all power domains are valid or powered up). To correctly signal power domain readiness in a multi-power domain integrated circuit, each power domain logically combines both internal and external power supply detection information using AND gates powered by the different power domains to generate separate power status signals for each power domain. Referring now to FIG. 2, there is shown a circuit block diagram of a motherboard system 200 having a split-rail APU ASIC 220 connected to receive different supply voltages VDD1, VDD2, VDDn from a plurality of voltage regulators. As illustrated, the APU ASIC 220 receives an external signal 216 from the voltage regulators regarding the readiness of the power rails VDD1, VDD2, VDDn, where the external signal 216 (System PowerOK Signal) is generated by connecting each voltage regulator for each power domain VDD1, VDD2, VDDn across a corresponding diode 211, 212, 213 to a shared signal node 215 which, in turn, is connected across load resistor 214 to supply voltage VDDx.

The APU ASIC 220 also includes an internal analog power-detection circuit 224 which generates a power good (PG) signal when all power rails are safe. Using a plurality of logic gates 226-228, the power good signal PG is logically combined with the external power rail signal (SystemPowerOK) provided at the input power status pin 222 (iPowerOK) to provide a power status indication to each power domain. In operation, the internal power detection circuit 224 is powered by the VDD1 power supply, so the power good signal PG generated at output 225 is on the VDD1 power domain. The power detection circuit 224 is configured to detect that all power domains sent to this power domain are good. To this end, the power-detection circuit 224 receives other supplies in order to sense them and determine their readiness. In selected embodiments, the readiness is determined by configuring the power-detection circuit 224 to function as a comparator circuit which compares the other supplies to detect that all powers sent to this circuit have passed a minimum voltage threshold. The internal power good signal PG is then “ANDed” with the external power rail signal (SystemPowerOK) on each of the destination power domains. For example, the power good signal PG and external power rail signal SystemPowerOK are combined by a first AND gate 226 that is powered by the VDD1 power domain, thereby generating a first power up signal 231 (POWER_OK) that is sent to the VDD1 power domain. In similar fashion, the power good signal PG and external power rail signal SystemPowerOK are combined by a second AND gate 227 powered by the VDD2 power domain to generate a second power up signal 232 (POWER_OK) that is sent to the VDD2 power domain, and so on. By logically combining the internally generated power good signal PG with the external power rail signal (SystemPowerOK) provided at the input power status pin 222 (iPowerOK), glitches from the external PowerOK signal are prevented from passing through, and the problem of logic-X propagation to the VDDn domain is also solved.

With the internal power detection circuit 224, all power domains will receive a power up signal POWER_OK that is a valid “0” (i.e. all powers are not yet stable) as long as the external power rail signal (SystemPowerOK) provided at the input power status pin 222 (iPowerOK) is “0” or the power supply which the internal power good signal is detected is up. Power domains that are not included in this circuit 221 will still have their respective power up signal (POWER_OK) sent to them from this circuit. These power domains will have their own power detection circuit to determine if the signal being received is driven on a valid power.

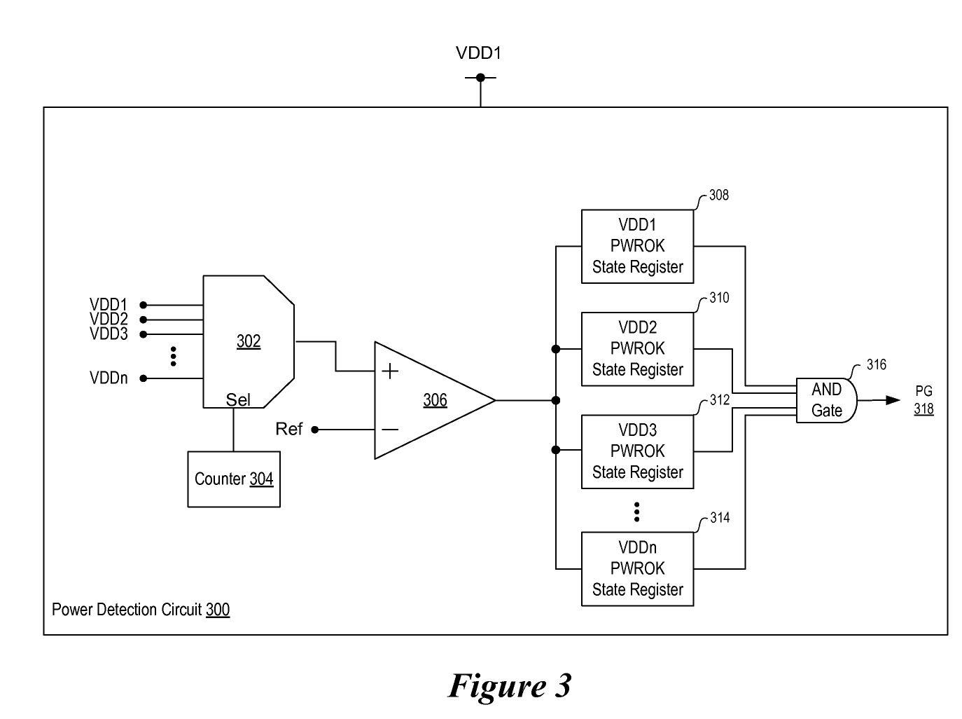

With the internal power detection circuit 224, any desired comparison circuit may be used to compare the various power domains to one or more reference levels. For example, FIG. 3 shows a circuit block diagram of an internal power detection circuit 300 in accordance with selected embodiments of the present invention. As illustrated, the power detection circuit is powered or supplied by the first power domain VDD1, and includes a first multiplexer circuit 302 which is connected to a plurality of power domains (VDD1, VDD2, VDD3, VDDn). Under control of a select signal provided by counter 302, the multiplexer circuit 302 selectively outputs each of the power domains to the comparison circuit 306 which compares the selected power domain to a reference voltage (Ref). When the comparison indicates that the selected power domain is below the reference voltage, the comparator 306 outputs a logic “0” for storage in the PWROK state register corresponding to the selected power domain. And when the power domain being compared is above the reference voltage, the comparator 306 outputs a logic “1” for storage in the corresponding PWROK state register. Thus, PWROK state registers 308, 310, 312, and 314 respectively store the comparison results for the power domains VDD1, VDD2, VDD3, and VDDn. Finally, multi-input AND gate circuit 316 logically combines the outputs of the PWROK state registers 308, 310, 312, and 314 to generate the output signal PG. If any of the power domains are not above the reference level, then the signal PG is output as a “0.” When all power domains are above the reference level, the signal PG will switch from “0” to “1.”

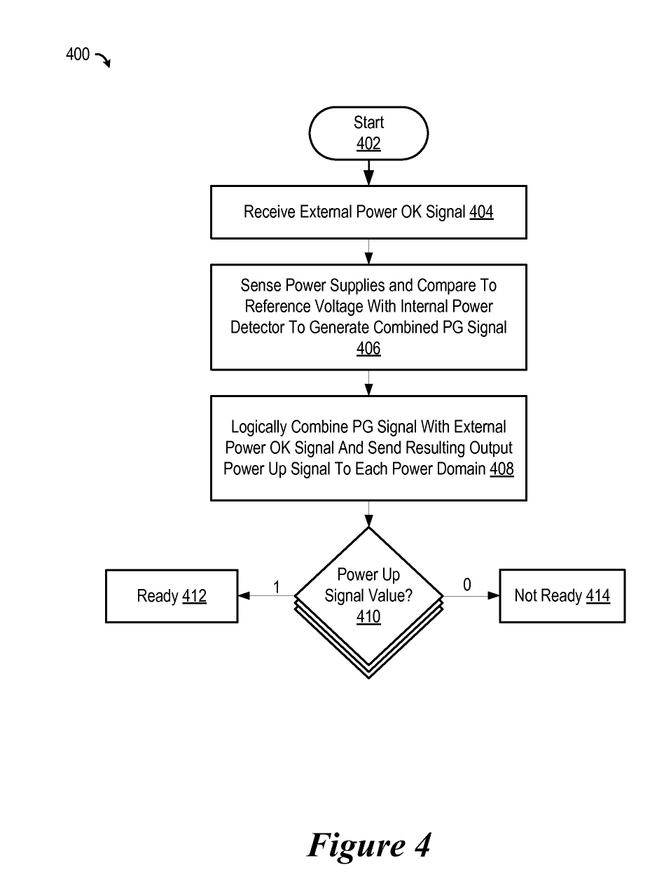

FIG. 4 depicts a process flow sequence 400 for implementing selected embodiments for powering up an integrated circuit. After the method begins at step 402, an external power ok signal (e.g., System PowerOK Signal) is received at a first power domain at step 404. The external power ok signal is provided by a plurality of voltage regulators and conveys information regarding the readiness of the power rails VDD1, VDD2, VDDn. The first external power ok signal is also received directly by all other power domains on the integrated circuit. As a result, each receiving power domain does not need any other power domain to be up in order to receive a valid “0” (where “0” indicates that all the powers are not stable).

At step 406, an internal power detection circuit at the first power domain detects that all powers are good, such as by detecting that all powers sent to this circuit have passed a minimum voltage threshold. The detection functionality may be implemented by sequentially connecting the power of various power domains (VDD1, VDD2, VDD3 VDDn) to a first input of a comparator circuit, where the second input is connected to the reference threshold voltage. Depending on whether the power domain being compared is above or below the reference voltage, the comparator will output a logical “1” or “0” to a power state register for the power domain. By logically combining the values from the power state registers for the power domains with an AND gate circuit, a power good output signal PG is generated to signal that all power domains are above the reference voltage level with a first logical value (e.g., 1), or that at least one of the power domains is not above the reference voltage level with a second logical value (e.g., 0). In selected embodiments, the power good output signal PG from the internal power detection circuit is on one power domain (e.g., VDD1).

At step 408, the power good output signal PG is logically combined with the external power ok signal (e.g., System PowerOK Signal) to generate a robust power up signal (POWER_OK) that may be sent to each destination power domain. In selected embodiments, the power up signal (POWER_OK) for each power domain is generated by AND-ing the power good output signal PG and external power ok signal (e.g., System PowerOK Signal) with a logical AND circuit that is powered by the power supply for that power domain.

At step 410, each power domain determines if the various power supplies for the subject power domain are ready (as indicated by the . If the power up signal (POWER_OK) is “1,” then the power supplies are ready and safe (step 412). However, if the power up signal (POWER_OK) is “0,” the power supplies are not ready (step 414). With the described example, as long as the external power ok signal (e.g., System PowerOK Signal) is “0” or the power supply which the internal power good signal is detected is up, all power domains will receive a valid “0” indicating that all powers are not yet stable.

Power domains that are not included in this circuit will still have the power up signal (POWER_OK) sent to them from this circuit. These power domains will have their own power detection circuit to determine if the signal being received is driven on a valid power. In this way, all voltage domains reliably determine whether all relevant power domains are up, thereby providing a robust power up sequence. In addition, any power removal (e.g., from improper shutdown of system) can be quickly detected.

As described herein, selected aspects of the invention as disclosed above may be implemented in hardware or software. For example, selected aspects of the embodiments described above may be implemented as functionality programmed into any of a variety of circuitry, including but not limited to multiplexer circuits, voltage generator circuits, comparator circuits, state register circuits, power supply circuits, power control circuits, which are controlled by one or more power safe signals which are generated by control modules, circuits, and/or hardware in response to power-up conditions at different voltage rails. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc. Thus, some portions of the detailed descriptions herein are consequently presented in terms of a hardware-implemented process and sonic portions of the detailed descriptions herein are consequently presented in terms of a software-implemented process involving symbolic representations of operations on data bits within a memory of a computing system or computing device. Generally speaking, computer hardware is the physical part of a computer, including its digital circuitry, as distinguished from the computer software that executes within the hardware. The hardware of a computer is infrequently changed, in comparison with software and hardware data, which are “soft” in the sense that they are readily created, modified or erased on the computer. These descriptions and representations are the means used by those in the art to convey most effectively the substance of their work to others skilled in the art using both hardware and software. Hardware embodiments of the invention may be fabricated based upon software code (e.g., Verilog, HDL, RTL or GDSII data) that is used to configure (e.g. through specific maskworks) a fabrication facility so as to manufacture a device embodying aspects of the present invention.

By now it will be appreciated that there is provided a method and apparatus for sensing power status information in an integrated circuit. As disclosed, the integrated circuit includes a plurality of power domains which are each coupled to receive power from a corresponding power source. Each power domain may include one or more circuits connected and configured to operate at a specified voltage so that different power domains operate at different voltages. In addition, a power sensing unit in the integrated circuit is coupled to receive an external power ok signal from the plurality of power sources and to generate a plurality of power status signals for delivery to a plurality of destination power domains. The external power ok signal may be received at an input pad on the power sensing unit. The power sensing unit includes an internal power detector and a power up signal generator circuit. The internal power detector is powered by a first power source (e.g., VDD1) and is coupled to sense power at the plurality of power sources and generate therefrom a power good signal having a first value indicating that all of the plurality of power sources are powered up. In selected embodiments, the internal power detector is a comparator circuit for comparing the plurality of power sources to a threshold reference voltage. In other embodiments, the internal power detectors includes a multiplexer circuit adapted to sequentially select and output each of the plurality of power sources coupled as a multiplexer output; a comparator circuit coupled to compare the multiplexer output to a threshold reference voltage and generate therefrom a digital power state value for each of the plurality of power sources; a plurality of power state registers for storing the digital power state values for the plurality of power sources; and an AND gate circuit for combining the digital power state values for the plurality of power sources into a power good signal having a first value indicating that all of the plurality of power sources are powered up. The power up signal generator circuit logically combines the external power ok signal with the power good signal on each of a plurality of destination power domains, thereby generating a power status signal for each of the plurality of destination power domains. In selected embodiments, the power up signal generator circuit uses a plurality of AND gate circuits to logically combine the external power ok signal with the power good signal on each of a plurality of destination power domains. For example, a first AND gate powered by a first power source VDD1 is coupled to receive the external power ok signal and the power good signal as inputs, thereby generating a first power status signal for a destination power domain associated with the first power source VDD1; and a second AND gate powered by a second power source VDD2 is coupled to receive the external power ok signal and the power good signal as inputs, thereby generating a second power status signal for a destination power domain associated with the second power source VDD2.

Embodiments of power sensing systems that can power up integrated circuits as described herein (such as the motherboard system 200) can be fabricated in semiconductor fabrication facilities according to various circuit designs. In one embodiment, a power sensing system design can be represented as code stored on a computer readable media. Exemplary codes that may be used to define and/or represent the power sensing system design may include HDL, Verilog, and the like. The code may be written by engineers, synthesized by one or more processing devices, and used to generate an intermediate representation of the power sensing system design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data. It is also contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, SRAMs, DRAMs, compact discs, DVDs, solid state storage devices and/or the like). In one embodiment, the GDSII data (or other similar data) may be adapted to configure a manufacturing facility (e.g., through the use of mask works) to create devices capable of embodying various aspects described herein, in the instant application. In other words, in various embodiments, this GDSII data (or other similar data) may be programmed into a computer, processor, or controller, which may then control, in whole or part, the operation of a semiconductor manufacturing facility (or fab) to create semiconductor products and devices. For example, in one embodiment, silicon wafers containing one or more CPUs, GPUs, DCTs, hardware state machines and/or algorithms (not shown), caches, and/or the like may be created using the GDSII data (or other similar data).

It should be noted that the disclosed methods, circuits, and systems are exemplary. Other electronic systems may also utilize multi-voltage integrated circuits having the same power-up scheme as that described above. The multi-voltage integrated circuits in such electronic systems may include processors or other types of integrated circuits. Furthermore, other embodiments of such electronic systems may include more than one multi-voltage integrated circuit having the power-up scheme described herein.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. An integrated circuit, comprising:
a plurality of power domains, wherein each of the plurality of power domains is coupled to receive power from a respective one of a plurality of power sources;
a power sensing unit coupled to receive an external power ok signal from the plurality of power sources and to generate a plurality of power status signals for delivery to a plurality of destination power domains, where the power sensing unit comprises:
an internal power detector that is powered by a first power source and coupled to sense power at the plurality of power sources, where the internal power detector generates a power good signal having a first value indicating that all of the plurality of power sources are powered up, and
a power up signal generator circuit for generating a corresponding power status signal for each of the plurality of destination power domains based on a logical combination of the external power ok signal with the power good signal on each of a plurality of destination power domains.

2. The integrated circuit of claim 1, where plurality of power domains comprise a first power domain of one or more circuits connected and configured to operate at a first voltage, and a second power domain of one or more circuits connected and configured to operate at a second voltage different from the first voltage.

3. The integrated circuit of claim 1, where the power sensing unit comprises an input pad coupled to receive the external power ok signal.

4. The integrated circuit of claim 1, where the power up signal generator circuit comprises a plurality of AND gate circuits for logically combining the external power ok signal with the power good signal on each of a plurality of destination power domains.

5. The integrated circuit of claim 4, where the plurality of AND gate circuits comprises:
a first AND gate powered by a first power source VDD1 and coupled to receive the external power ok signal and the power good signal as inputs, thereby generating a first power status signal for a destination power domain associated with the first power source VDD1; and
a second AND gate powered by a second power source VDD2 and coupled to receive the external power ok signal and the power good signal as inputs, thereby generating a second power status signal for a destination power domain associated with the second power source VDD2.

6. The integrated circuit of claim 1, where the internal power detector comprises a comparator circuit for comparing the plurality of power sources to a threshold reference voltage.

7. The integrated circuit of claim 1, where the internal power detector comprises:
a multiplexer circuit adapted to sequentially select and output each of the plurality of power sources coupled as a multiplexer output;
a comparator circuit coupled to compare the multiplexer output to a threshold reference voltage and generate therefrom a digital power state value for each of the plurality of power sources;
a plurality of power state registers for storing the digital power state values for the plurality of power sources; and
an AND gate circuit for combining the digital power state values for the plurality of power sources into a power good signal having a first value indicating that all of the plurality of power sources are powered up.

8. A method for powering an integrated circuit comprising:
providing power from a plurality of power sources to a corresponding plurality of power domains in the integrated circuit;
providing a first power ok signal to each of the plurality of power domains;
detecting readiness of the plurality of power sources at a first power domain by generating a second power ok signal when all of the plurality of power sources are ready; and
generating a power status signal for each of a plurality of destination power domains based on a logical combination of the first power ok signal with the second power ok signal on each of a plurality of destination power domains.

9. The method of claim 8, further comprising sending each power status signal to a corresponding power domain.

10. The method of claim 8, where providing power from the plurality of power sources comprises connecting a first supply voltage to one or more circuits in a first power domain and connecting a second supply voltage to one or more circuits in a second power domain.

11. The method of claim 8, where providing the first power ok signal comprises connecting a plurality of output power ok signals from the plurality of power sources across a corresponding plurality of diodes to a shared node that is coupled across a resistor load to a first supply voltage, where each of the plurality of diodes has a cathode terminal connected to receive a output power ok signal and an anode terminal connected to the shared node, thereby generating the first power ok signal at the shared node.

12. The method of claim 8, where providing the first power ok signal comprises driving the first power ok signal high when all of the plurality of power sources are ready.

13. The method of claim 8, where providing the first power ok signal comprises providing the first power ok signal to an input pad of a power sensing unit.

14. The method of claim 8, where generating the power status signal comprises applying the first power ok signal and the second power ok signal as inputs to each of a plurality of AND gate circuits.

15. The method of claim 14, where the plurality of AND gate circuits separately powered by the plurality of destination power domains.

16. The method of claim 14, where the plurality of AND gate circuits comprises:
a first AND gate powered by a first power source VDD1 and coupled to receive the first power ok signal and the second power ok signal as inputs, thereby generating a first power status signal for a destination power domain associated with the first power source VDD1; and
a second AND gate powered by a second power source VDD2 and coupled to receive the first power ok signal and the second power ok signal as inputs, thereby generating a second power status signal for a destination power domain associated with the second power source VDD2.

17. The method of claim 8, where detecting readiness of the plurality of power sources comprises comparing each of the plurality of power sources to a threshold reference voltage.

18. The method of claim 17, where detecting readiness of the plurality of power sources comprises storing a digital comparison result for each destination power domain based on the comparison of each power source to the threshold reference voltage.

19. The method of claim 17, where comparing each of the plurality of power sources to a threshold reference voltage is performed is performed on a first power domain.

20. A non-transitory computer-readable storage medium comprising instructions and data that are acted upon by a program executable on a computer system, the program operating on the instructions and data to perform a portion of a process to fabricate an integrated circuit including circuitry described by the data, the circuitry described by the data comprising:
power sensing circuitry coupled to receive an external power ok signal from a plurality of power sources and to generate a plurality of power status signals for delivery to a plurality of destination power domains, where the power sensing circuitry comprises:
internal power detection circuitry that is powered by a first power source and coupled to sense power at the plurality of power sources, where the internal power detection circuitry generates a power good signal having a first value indicating that all of the plurality of power sources are powered up, and
power up signal generator circuitry for generating a corresponding power status signal for each of the plurality of destination power domains based on a logical combination of the external power ok signal with the power good signal on each of a plurality of destination power domains.
